(19) United States
(12) Patent Application Publication
(10) Pub. No.: US 2026/0119066 A1
(43) Pub. Date: Apr. 30, 2026

(54) ELECTRONIC DEVICE AND SYSTEM INCLUDING THE SAME

(71) Applicant: LG ELECTRONICS INC., Seoul (KR)

(72) Inventors: Kihun LEE, Seoul (KR); Haeyong PYUN, Seoul (KR)

(73) Assignee: LG ELECTRONICS INC., Seoul (KR)

(21) Appl. No.: 19/304,963

(22) Filed: Aug. 20, 2025

(30) Foreign Application Priority Data
Aug. 23, 2024 (WO) PCT/KR2024/012638

(51) Int. Cl. G06F 3/06

(52) U.S. Cl. CPC G06F 3/0644; G06F 3/062; G06F 3/0683

(57) ABSTRACT

The present disclosure relates to an electronic device and a system including the same. An electronic device according to an embodiment of the present disclosure includes a memory including a plurality of partitions; and a controller, wherein the controller obtains image data including binaries, in response to a performance of an update for a program stored in the memory, stores some of the binaries in a first partition, and stores remainder of the binaries in a second partition, when it is required to separate and store the binaries in the plurality of partitions, and stores the binaries in the second partition, when it is not required to separate and store the binaries in the plurality of partitions.

### CROSS-REFERENCE TO RELATED APPLICATION(S)

Pursuant to 35 U.S.C. § 119, this application claims the benefit of earlier filing date and right of priority to International Application No. PCT/KR2024/012638, filed on Aug. 23, 2024, the contents of which is hereby incorporated by reference herein in its entirety.

### TECHNICAL FIELD

This disclosure relates to an electronic device and a system including the same, and more particularly, to an electronic device for updating a program stored in the electronic device and a system including the same.

### BACKGROUND

Electronic devices refer to electronic engineering devices that are frequently used in daily life, such as computer, smartphones display device, refrigerator, air conditioner, and washing machine. Electronic devices store programs that contain specific commands to control various functions.

In general, after an electronic device is sold, only simple technical support, such as error correction for the programs stored in the electronic device, is provided, and when an upgraded electronic device that provides new functionality is required, a user must purchase a new electronic device. H However, purchasing a new electronic device every time a new function is added not only imposes a financial burden on a user, but also causes an environmental burden when discarding existing electronic devices or producing new electronic devices. To solve this problem, various studies have been conducted to upgrade, update, or replace the software of electronic devices by using a network, etc. so that existing electronic devices can provide new functions.

### SUMMARY

The present disclosure aims to solve the aforementioned problems and other problems.

The disclosure may further allow an electronic device to update software, despite the limitation of the size of a partition of a memory where program is stored.

The disclosure may further allow an electronic device to provide a function by using a program stored in different partitions together.

In order to achieve the above purpose, an electronic device according to an embodiment of the present disclosure includes a memory including a plurality of partitions; and a controller, in which the controller obtains image data including binaries, in response to a performance of an update for a program stored in the memory, stores some of the binaries in a first partition, and stores remainder of the binaries in a second partition, when it is required to separate and store the binaries in the plurality of partitions, and stores the binaries in the second partition, when it is not required to separate and store the binaries in the plurality of partitions. In order to achieve the above purpose, a system according to another embodiment of the present disclosure includes a server and an electronic device, in which the server generates image data including binaries, and the electronic device obtains image data from the server, in response to a performance of an update for a program stored in a memory of the electronic device, stores some of the binaries in a first partition, and stores remainder of the binaries in a second partition, when it is required to separate and store the binaries in a plurality of partitions of the memory, and stores the binaries in the second partition, when it is not required to separate and store the binaries in the plurality of partitions.

### BRIEF DESCRIPTION OF THE DRAWINGS

The above and other objects, features and advantages of the present disclosure will be more apparent from the following detailed description in conjunction with the accompanying drawings, in which:

FIG. 1 is a diagram illustrating a system, according to an embodiment of the present disclosure;

FIG. 2 is an internal block diagram of a display device of FIG. 1;

FIG. 3 is a block diagram for explaining a configuration of a server of FIG. 1;

FIG. 4 is a flowchart for an operation method of an electronic device for updating a program, according to an embodiment of the present disclosure;

FIG. 5 to FIG. 10 are drawings for explaining the operation of an electronic device for updating a program, according to an embodiment of the present disclosure;

FIG. 11 is a flowchart for an operation method of an electronic device using a program, according to an embodiment of the present disclosure; and

FIG. 12 is a flowchart for an operation method of a server, according to an embodiment of the present disclosure.

### DETAILED DESCRIPTION

Hereinafter, the present disclosure will be described in detail with reference to the drawings. In the drawings, in order to clearly and concisely describe the present disclosure, parts that are not related to the description are omitted, and the same drawing reference numerals are used for identical or extremely similar parts throughout the specification.

The suffixes “module” and “part” used for components in the following description are given simply for the convenience of writing this specification, and do not in themselves impart any particularly important meaning or role. Therefore, the above “module” and “part” may be used interchangeably.

In the present application, it should be understood that the terms “comprises, includes,” “has,” etc. specify the presence of features, numbers, steps, operations, elements, components, or combinations thereof described in the specification, but do not preclude the presence or addition of one or more other features, numbers, steps, operations, elements, components, or combinations thereof.

In addition, in this specification, terms such as first, second, etc. may be used to describe various elements, but these elements are not limited by these terms. These terms are used only to distinguish one element from another.

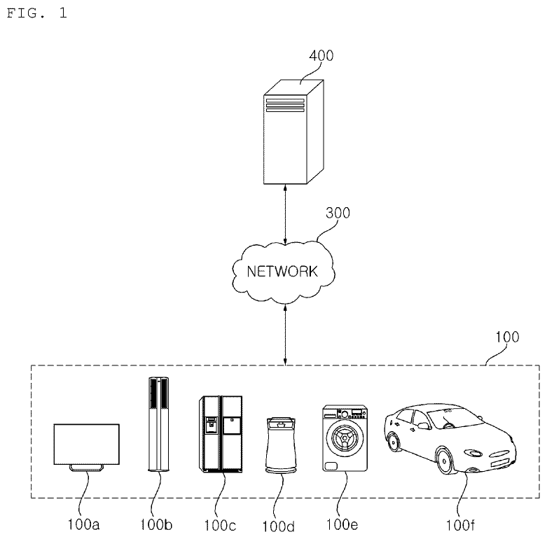

FIG. 1 is a diagram illustrating a system, according to various embodiments of the present disclosure.

Referring to FIG. 1, a system 10 may include an electronic device 100 and/or a server 400.

The electronic device 100 may mutually transmit and receive data to and from at least one server 400. For example, the electronic device 100 may transmit and receive data to and from at least one server 400 via a network 300 such as the Internet.

The electronic device 100 may include a display device 100a, an air conditioner 100b, a refrigerator 100c, an air purifier 100d, a washing machine 100e, a vehicle 100f, and the like. In the present disclosure, the electronic device 100 is described as an example of a display device 100a, but the present disclosure is not limited thereto. The display device 100a may be a device that processes and outputs an image. The display device 100a is not particularly limited as long as it can output a screen corresponding to an image signal, such as a TV, a notebook computer, and a monitor.

The display device 100a may receive a broadcast signal, process the signal, and output a signal-processed broadcast image. When the display device 100a receives a broadcast signal, the display device 100a may correspond to a broadcast receiving device.

The display device 100a may receive a broadcast signal wirelessly through an antenna, or may receive a broadcast signal wiredly through a cable. For example, the display device 100a may receive a terrestrial broadcast signal, a satellite broadcast signal, a cable broadcast signal, an Internet Protocol Television (IPTV) broadcast signal, etc.

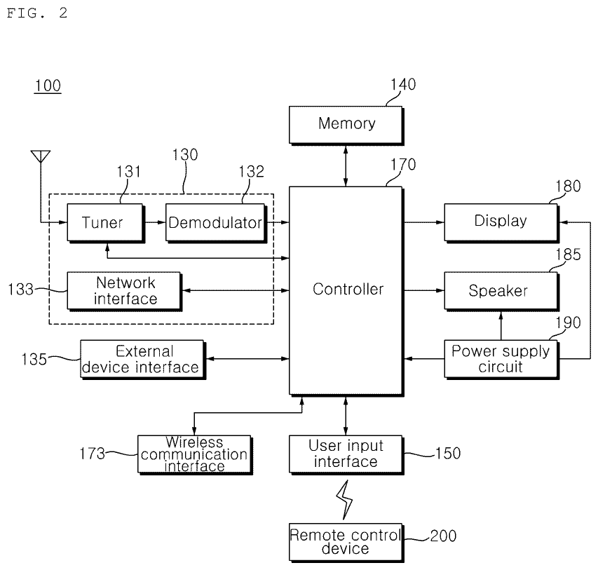

FIG. 2 is an internal block diagram of the display device of FIG. 1.

Referring to FIG. 2, the display device 100 may include an image receiver 130, an external device interface 135, a memory 140, a user input interface 150, a controller 170, a wireless communication interface 173, a display 180, a speaker 185, and a power supply circuit 190.

The image receiver 130 may include a tuner 131, a demodulator 132, and a network interface 133.

The tuner 131 may select a specific broadcast channel according to a channel selection command. The tuner 131 may receive a broadcast signal for the selected specific broadcast channel.

The demodulator 132 may separate the received broadcast signal into a video signal, an audio signal, and a data signal related to a broadcast program, and may restore the separated video signal, audio signal, and data signal into a form that can be output.

The external device interface 135 may receive an application or an application list in an adjacent external device, and transmit it to the controller 170 or memory 140.

The external device interface 135 may provide a connection path between the display device 100 and an external device. The external device interface 135 may receive one or more of image and audio output from the external device connected wirelessly or wiredly to the display device 100, and transmit it to the controller 170. The external device interface 135 may include a plurality of external input terminals. The plurality of external input terminals may include an RGB terminal, one or more High Definition Multimedia Interface (HDMI) terminals, and a component terminal.

The image signal of the external device input through the external device interface 135 may be output through the display 180. The audio signal of the external device input through the external device interface 135 may be output through the speaker 185.

The external device that can be connected to the external device interface 135 may be any one of a set-top box, a Blu-ray player, a DVD player, a game console, a sound bar, a smartphone, a PC, a USB memory, and a home theater, but this is just an example.

The network interface 133 may provide an interface for connecting the display device 100 to a wired/wireless network including the Internet. The network interface 133 may transmit or receive data to or from other users or other electronic devices, through an accessed network or another network linked to the accessed network.

In addition, some content data stored in the display device 100 may be transmitted to a selected user or electronic device among other users or other electronic devices pre-registered in the display device 100.

The network interface 133 may access a certain web page through the accessed network or another network linked to the accessed network. That is, it may access a certain web page through the network, and transmit or receive data with a corresponding server.

In addition, the network interface 133 may receive content or data provided by a content provider or a network operator. That is, the network interface 133 may receive content such as movie, advertisement, game, VOD, broadcast signal provided from a content provider or a network provider through the network, and information related thereto.

In addition, the network interface 133 may receive the update information and update file of firmware provided by a network operator, and may transmit data to the Internet, the content provider, or network operator.

The network interface 133 may select and receive a desired application from among applications opened to the public through the network.

The memory 140 may store programs for processing and controlling each signal in the controller 170, and may store signal-processed images, voices, or data signals.

In addition, the memory 140 may perform a function for temporary storage of images, voices, or data signals input from the external device interface 135 or the network interface 133, and may store information related to a given image through a channel memory function.

The memory 140 may store an application or a list of applications input from an external device interface 135 or a network interface 133.

The display device 100 may play content files (video files, still image files, music files, document files, application files, etc.) stored in the memory 140 and provide them to a user.

The user input interface 150 may transmit a signal input by a user to the controller 170, or transmit a signal from the controller 170 to a user. For example, the user input interface 150 may receive and process control signals such as power on/off, channel selection, and screen setting from the remote control device 200, or process the control signals from the controller 170 to transmit them to the remote control device 200, according to various communication methods such as Bluetooth, Ultra Wideband (WB), ZigBee method, Radio Frequency (RF) communication method, or infrared IR communication method.

In addition, the user input interface 150 may transmit a control signal input from a local key (not shown) such as a power key, a channel key, a volume key, and a setting value, to the controller 170.

The image signal processed by the controller 170 may be input to the display 180 and displayed as an image corresponding to a relevant image signal. In addition, the image signal processed by the controller 170 may be input to an external output device through the external device interface 135.

The voice signal processed by the controller 170 may be audio-outputted through the speaker 185. In addition, the voice signal processed by the controller 170 may be input to the external output device through the external device interface 135.

In addition, the controller 170 may control the overall operation within the display device 100.

In addition, the controller 170 may control the display device 100 by a user command or an internal program input through the user input interface 150, and may allow a user to download a desired application or application list into the display device 100 by accessing a network.

The controller 170 may allow user-selected channel information, etc. to be output through the display 180 or speaker 185 together with the processed image or voice signal. In addition, the controller 170 may allow the image signal or voice signal from an external device, such as a camera or camcorder, input through the external device interface 135 to be output through the display 180 or speaker 185, according to an external device image playback command received through the user input interface 150.

Meanwhile, the controller 170 may control the display 180 to display an image, for example, may control the display 180 to display a broadcast image input through the tuner 131, an external input image input through the external device interface 135, an image input through the network interface, or an image stored in the memory 140. In this case, the image displayed on the display 180 may be a still image or a moving image, and may be a 2D image or a 3D image.

In addition, the controller 170 may control the playback of content stored in the display device 100, received broadcast content, or external input content input from the outside, and the content may be in various forms such as broadcast image, external input image, audio file, still image, accessed web screen, and document file.

The wireless communication interface 173 may perform communication with an external device through wired or wireless communication. The wireless communication interface 173 may perform short range communication with the external device. To this end, the wireless communication interface 173 may support short range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (Wireless USB) technology. The wireless communication interface 173 may support wireless communication between the display device 100 and a wireless communication system, between the display device 100 and other display device 100, or between the display device 100 and a network where the display device 100 (or an external server) is located, via a wireless area network. The wireless area network can be a wireless personal area network.

Here, other display device 100 may be an electronic device, such as a wearable device (e.g., a smartwatch, smart glass), a head mounted display (HMD), and a smart phone, that can exchange (or can be linked) data with the display device 100 according to the present disclosure. The wireless communication interface 173 may detect (or recognize) a communicable wearable device in the vicinity of the display device 100.

Furthermore, when the detected wearable device is a device certified to communicate with the display device 100 according to the present disclosure, the controller 170 may transmit at least a portion of the data processed in the display device 100 to the wearable device through the wireless communication interface 173. Accordingly, a user of the wearable device may use the data processed in the display device 100 through the wearable device.

The display 180 may generate a driving signal by converting the image signal, data signal, and OSD signal processed in the controller 170 or converting the image signal, data signal, etc. received from the external device interface 135 into R, G, B signal, respectively.

Meanwhile, since the display device 100 illustrated in FIG. 2 is just an embodiment of the present disclosure, a portion of the illustrated components may be integrated, added, or omitted depending on the specifications of the display device 100 that is actually implemented.

That is, two or more components may be combined into one component, or one component may be subdivided into two or more components, if necessary. In addition, the functions performed by each block are for the purpose of explaining an embodiment of the present disclosure, and the specific operations or devices thereof do not limit the scope of the present disclosure.

According to another embodiment of the present disclosure, unlike FIG. 2, the display device 100 may receive and play an image through the network interface 133 or the external device interface 135 without having the tuner 131 and the demodulator 132.

For example, the display device 100 may be implemented by separating it into an image processing device, such as a set-top box for receiving contents according to a broadcast signal or various network services, and a content playback device for playing contents input from the image processing device. In this case, the operation method of the display device according to an embodiment of the present disclosure to be described below may be performed by not only the display device 100 described with reference to FIG. 2, but also by any one of the image processing device such as the separated set-top box or the content playback device having the display 180 and the speaker 185.

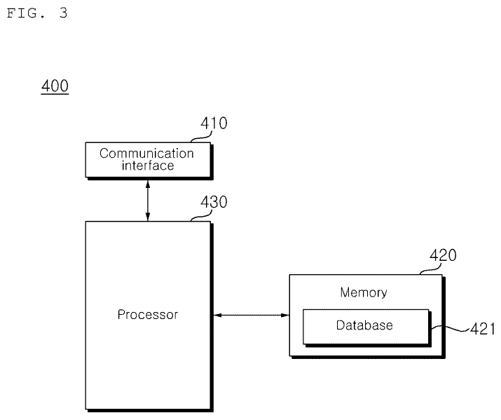

FIG. 3 is a block diagram for explaining the configuration of the server of FIG. 1.

Referring to FIG. 3, the server 400 may include a communication interface 410, a memory 420, and/or a processor 430.

The communication interface 410 may include at least one communication module for connection with a network 500. The communication interface 410 may access the network 300 and communicate with the electronic device 100.

The memory 420 may store a program for processing and controlling each signal within the processor 430, or may store a signal-processed data signal. For example, the memory 420 may store application programs designed for the purpose of performing various tasks that can be processed by the processor 430, and may selectively provide some of the stored application programs when requested by the processor 430. The programs stored in the memory 420 are not particularly limited as long as they can be executed by the processor 430.

The memory 420 of FIG. 3 is provided separately from the processor 430, but the scope of the present disclosure is not limited thereto, and the memory 420 may be included in the processor 430.

The memory 420 may include at least one of volatile memory (e.g., DRAM, SRAM, SDRAM, etc.) and nonvolatile memory (e.g., flash memory, hard disk drive (HDD), solid-state drive (SSD), etc.).

The memory 420 may store at least one database 421. The database 421 may include image data that updates a program stored in the memory 140 of the electronic device 100. For example, the database 421 may include a plurality of image data classified by model of the electronic device 100. Here, the image data may mean data that is encoded, compressed, and/or packaged in a format that can be processed by the controller 170 of the electronic device 100. The program may be referred to as binary, code, etc. The image data may be referred to as package data, binary package, package image, etc.

The processor 430 may be connected to each component provided in the server 400, and may control the overall operation of each component. The processor 430 may transmit and receive data to and from each component provided in the server 400.

The processor 430 may transmit and receive various signals containing data to and from the electronic device 100, through the communication interface 410.

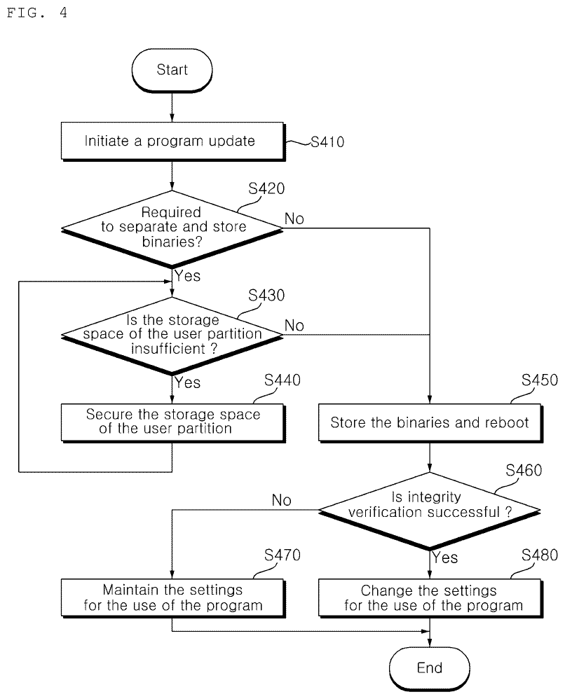

FIG. 4 is a flowchart of an operation method of an electronic device for updating a program, according to an embodiment of the present disclosure.

Referring to FIG. 4, the electronic device 100 may initiate an update for a program stored in the memory 140, at operation S410. For example, the electronic device 100 may initiate an update for a program, based on the reception of a signal instructing an update of the program from the server 400. For example, the electronic device 100 may initiate an update of the program, based on the fact that the database 421 of the server 400 contains image data used for updating the program. For example, the electronic device 100 may initiate an update of the program, based on the fact that the version of the image data previously received from the server 400 and the version of the image data contained in the database 421 of the server 400 are different from each other. For example, the electronic device 100 may initiate an update of the program, based on the fact that an external device providing the image data used for updating the program is connected to the external device interface 135.

In an embodiment, the electronic device 100 may determine whether to initiate an update of the program, based on a user input received through the user input interface 150. For example, the electronic device 100 may initiate an update of the program, based on the fact that a user input for initiating an update of the program is received. For example, the electronic device 100 may stop an update of the program, based on the reception of a user input for stopping an update of the program.

The electronic device 100 may determine whether it is required to separate and store binaries included in the image data in different partitions of the memory 140, at operation S420.

According to an embodiment, the electronic device 100 may determine whether it is required to store binaries included in the image data in different partitions, before receiving the image data from the server 400.

For example, the electronic device 100 may determine whether binaries stored in different partitions are included in the image data, based on information related to the image data provided by the server 400.

According to an embodiment, the electronic device 100 may determine whether it is required to store binaries included in the image data in different partitions, after receiving the image data from the server 400. For example, the electronic device 100 may check the header of the binaries included in the image data to determine whether the binaries are stored in different partitions. For example, the electronic device 100 may compare the size of binaries included in the image data with the size of a certain partition, among the partitions of the memory 140, that is preset to store binaries, and determine whether to store some of the binaries included in the image data in another partition other than the certain partition.

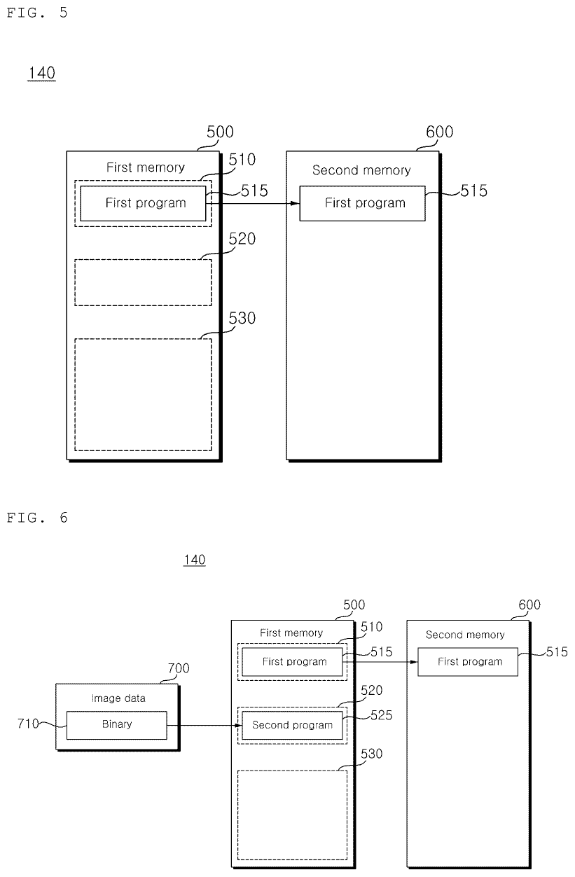

Referring to FIG. 5, the memory 140 of the electronic device 100 may include a first memory 500 and a second memory 600. The first memory 500 may be a nonvolatile memory such as a flash memory, a hard disk drive (HDDO, and a solid state drive (SSD). The second memory 600 may be a volatile memory such as a DRAM, an SRAM, an SDRAM, and a buffer.

The first memory 500 may include a plurality of partitions that are separated from each other. The first memory 500 may include a partition 510, 520 to which user access is restricted and a partition 530 to which user access is permitted. For example, a program for an operating system (OS) of the electronic device 100 may be stored in the partition 510, 520 to which user access is restricted, and data corresponding to a user may be stored in the partition 530 to which user access is permitted. The partition 510, 520 to which user access is restricted may be referred to as a Read-Only (RO) partition, an OS partition, etc. The partition 530 to which user access is permitted may be referred to as a Read-Write (RW) partition, a user partition, etc.

The electronic device 100 may load a program stored in the first memory 500 into the second memory 600. The process of setting up a program stored in the first memory 500 to be loaded into the second memory 600 and used in an operating system environment may be referred to as mounting. For example, when the electronic device 100 is booted, the first program 515 stored in a first OS partition 510 may be loaded into the second memory 600 by a boot loader. At this time, when the controller 170 executes the mounted first program 515, the operating system may be executed to operate the electronic device 100.

Referring to FIG. 6, the image data 700 received from the server 400 may include binaries 710. The total size of the binaries 710 included in the image data 700 may be less than or equal to the size of a second OS partition 520.

The electronic device 100 may store all binaries 710 included in the image data 700 in the second OS partition 520. The binaries 710 included in the image data 700 may be stored in the second OS partition 520 as a second program 525.

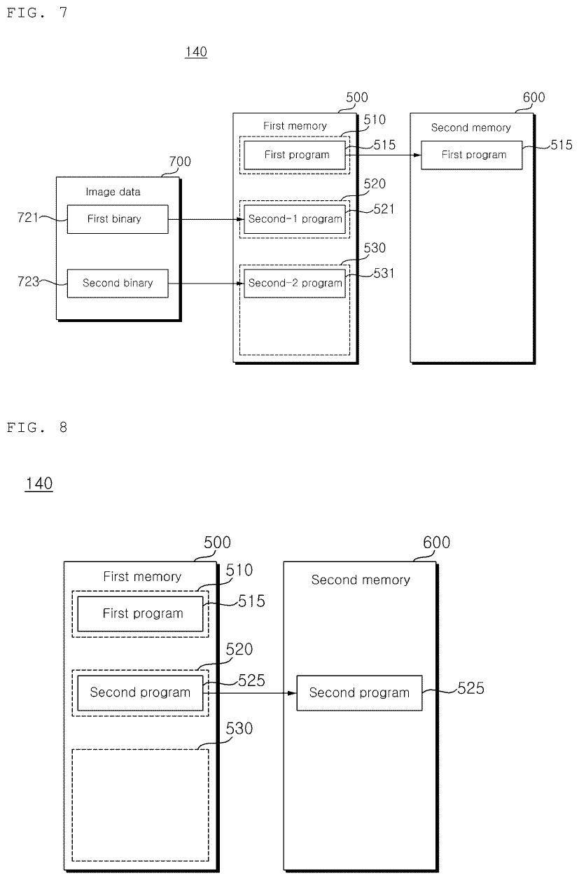

Meanwhile, referring to FIG. 7, image data 700 received from the server 400 may include binaries 721, 723. The total size of the binaries 721, 722 included in the image data 700 may exceed the size of the second OS partition 520.

The electronic device 100 may store some 721 of the binaries 721, 723 included in the image data 700 in the second OS partition 520, and store the remaining part 723 in a user partition 530. For example, the electronic device 100 may determine the partition in which the binaries 721, 723 are stored, based on the header of the binary included in the image data 700.

Some 721 of the binaries 721, 722 included in the image data 700 may be stored in the second OS partition 520 as a second-1 program 521, and the remaining part 723 may be stored in the user partition 530 as a second-2 program 531.

In this disclosure, the first program 515 stored in the first OS partition 510 is described as an example of updating the program while the first program 515 is mounted, but the present disclosure is not limited thereto.

For example, when the program stored in the second OS partition 520 is mounted, binaries included in the image data 700 may be at least stored in the first OS partition 510.

Referring again to FIG. 4, when it is required to store binaries included in the image data in different partitions of the memory 140, the electronic device 100 may determine whether the storage space of the user partition for storing binaries included in the image data is insufficient, at operation S430. For example, the electronic device 100 may determine whether the storage space of the user partition for storing binaries is insufficient, by comparing the size of the remaining binaries excluding a part stored in the OS partition, among the binaries included in the image data, with the size of the available storage space in the user partition.

According to an embodiment, the electronic device 100 may determine whether to use the user partition based on a user input, when it is required to store binaries included in the image data in different partitions of the memory 140. For example, the electronic device 100 may output a message for the use of the user partition through the display 180. The message for the use of the storage space of the user partition may include the size of the storage space available in the user partition, the size of the storage space required for storing the binary, etc. At this time, the electronic device 100 may proceed with an update of the program, when a first input agreeing to the use of the user partition is received through the user input interface unit 150. Meanwhile, the electronic device 100 may stop the update of the program, when a second input disagreeing to the use of the user partition is received through the user input interface unit 150.

If the storage space of the user partition for storing the binary is insufficient, the electronic device 100 may secure the storage space of the user partition in response to the size of the binary, at operation S440. For example, the electronic device 100 may secure the storage space of the user partition by deleting a temporary file among the data stored in the user partition. For example, the electronic device 100 may output a message requesting the deletion of the data stored in the user partition through the display 180.

The electronic device 100 may store the binaries included in the image data in the memory 140, at operation S450. For example, if it is not required to store the binaries included in the image data in different partitions, the electronic device 100 may store all the binaries included in the image data in the OS partition. For example, if the electronic device 100 is required to store binaries included in the image data in different partitions, some of the binaries included in the image data may be stored in the OS partition and the remaining may be stored in the user partition.

The electronic device 100 may perform a reboot, when the binaries included in the image data are stored in the memory 140.

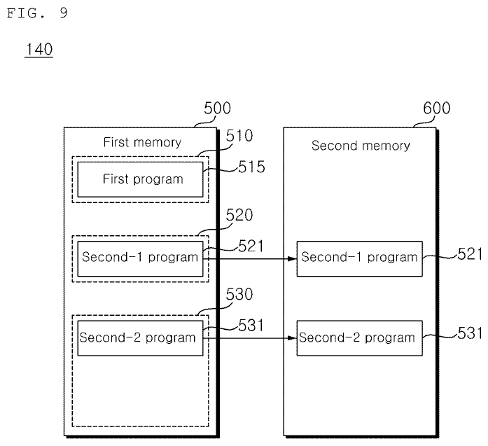

Referring to FIG. 8, in the state where the mounting target for the second memory 600 is set to the first program 515 stored in the first OS partition 510, when the second program 525 is stored in the second OS partition 520, the electronic device 100 may change the mounting target to the second program 525 stored in the second OS partition 520.

The electronic device 100 may perform a reboot through mounting for the second program 525. At this time, the electronic device 100 may perform integrity verification of the mounted second program 525. For example, the electronic device 100 may perform integrity verification of the second program 525, by using device-mapper-verity (dm-verity), cyclic redundancy check (CRC), etc.

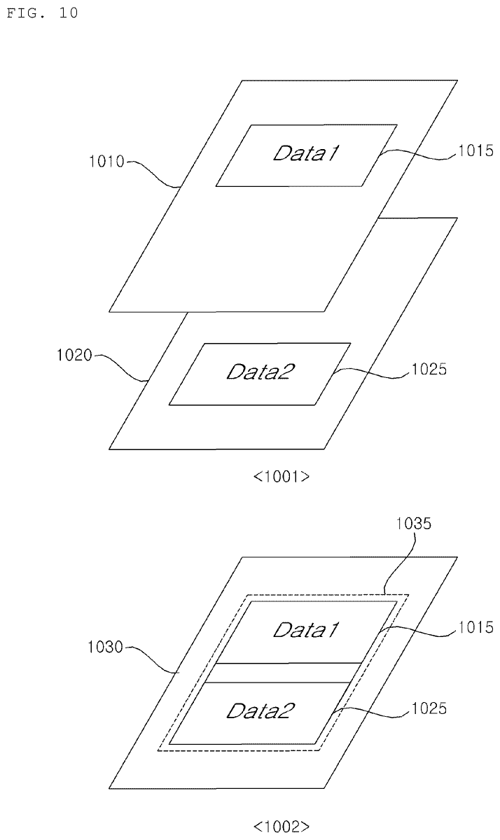

Referring to FIG. 9, in the state where the mounting target for the second memory 600 is set to the first program 515 stored in the first OS partition 510, when the second-1 program 521 and a second-2 program 523 are stored in the second OS partition 520 and the user partition 530, respectively, the electronic device 100 may change the mounting target to the second-1 program 521 stored in the second OS partition 520 and the second-2 program 531 stored in the user partition 530.

The electronic device 100 may perform a reboot by mounting the second-1 program 521 and the second-2 program 531. At this time, the electronic device 100 may perform integrity verification of the whole of the mounted second-1 program 521 and the second-2 program 531.

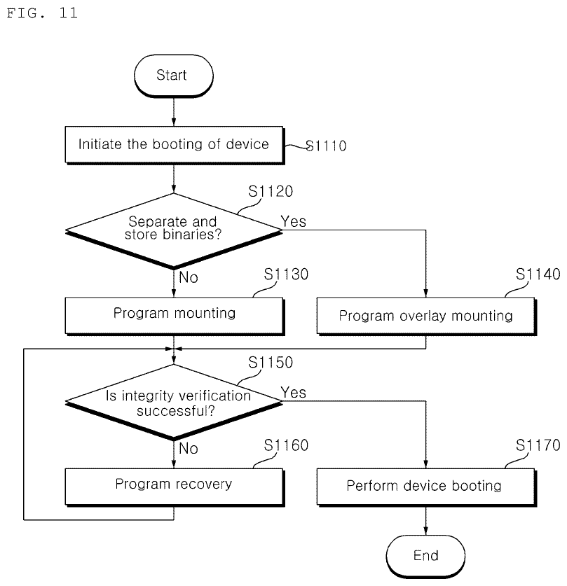

According to an embodiment, the electronic device 100 may perform overlay mounting, with respect to programs that are stored in the plurality of partitions respectively. The overlay mounting will be described with reference to FIG. 10.

Referring to FIG. 10, the overlay file system applied to the overlay mounting may be implemented as OverlayFS, etc., which is available in Linux kernel 3.18 onwards. The overlay file system may include an upper first layer 1010 and a lower second layer 1020. According to an embodiment, both the first layer 1010 and the second layer 1020 may be a Read-Only (RO) layer. In the overlay file system, the layers may also be referred to as a directory.

A first data 1015 may be implemented in the first layer 1010, and a second data 1025 may be implemented in the second layer 1020. At this time, in an integrated layer 1030 for the first layer 1010 and the second layer 1020, it may be implemented to have a structure 1035 in which the first data 1015 of the first layer 1010 and the second data 1025 of the second layer 1020 are overlapped and connected to each other.

The electronic device 100 may mount the second-1 program 521 stored in the second OS partition 520 to the second memory 600. At this time, the electronic device 100 may mount the second-2 program 531 stored in the user partition 530 so as to be overlaid on the second-1 program 521 mounted in the second memory 600. Therefore, the electronic device 100 may use data of a structure in which the second-1 program 521 and the second-2 program 531 are connected to each other through overlay mounting.

Meanwhile, the location, area, or address where the second-1 program 521 and the second-2 program 531 are overlaid may be preset in the image data 700. The electronic device 100 may store and manage the location, area, or address preset in the image data 700 in the first memory 500.

Referring again to FIG. 4, the electronic device 100 may determine whether the integrity verification for the mounted program is successful, at operation S460. At operation S470, based on a failure of the integrity verification for the mounted program, the electronic device 100 may maintain the settings for the use of the program as the state before the update of the program. For example, the electronic device 100 may perform a roll-back process to change the mounting target for the second memory 600 set during the reboot process back to the first program 515.

At operation S480, if the integrity verification for the mounted program is successful, the electronic device 100 may change the settings for the use of the program to a state different from the state before the update of the program. For example, the electronic device 100 may maintain the mounting target for the second memory 600 set during the reboot process.

According to an embodiment, the electronic device 100 may delete the program stored in the memory 140 before the update of the program. For example, if the update of the program is completed, the electronic device 100 may delete the first program 515 previously stored in the first memory 500.

According to an embodiment, the electronic device 100 may store a backup binary corresponding to the binaries included in the image data 700 in the memory 140. For example, when the update of the program is completed, the electronic device 100 may store the backup binary in the user partition.

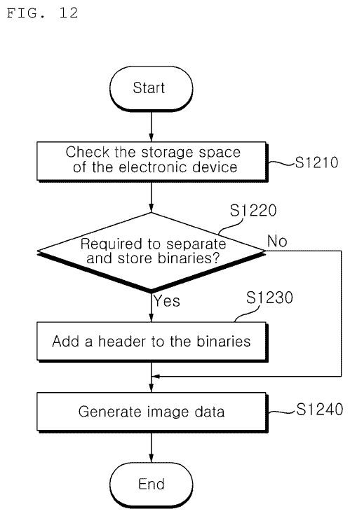

FIG. 11 is a flowchart of an operation method of an electronic device using a program, according to an embodiment of the present disclosure. Detailed descriptions of contents overlapping with those described in FIGS. 4 to 10 will be omitted.

Referring to FIG. 11, the electronic device 100 may initiate booting, at operation S1110. For example, when the power of the electronic device 100 is turned on from an off state, the electronic device 100 may be booted.

The electronic device 100 may check whether the binaries used for executing the operating system are stored separately in the plurality of partitions of the memory 140, at operation S1120.

At operation S1130, if the binaries used for executing the operating system are stored in one partition, the electronic device 100 may perform mounting for the binaries stored in one partition. For example, the electronic device 100 may mount the binaries stored in one preset partition among a plurality of multiple OS partitions.

At operation S1140, if the binaries used for executing the operating system are stored separately in the plurality of partitions, the electronic device 100 may perform overlay mounting on the binaries stored in the plurality of partitions.

At operation S1150, the electronic device 100 may perform integrity verification of the mounted program to determine whether the integrity verification is successful.

Based on a failure of the integrity verification of the mounted program, the electronic device 100 may perform recovery of the program stored in the memory 140, at operation S1160. For example, the electronic device 100 may perform recovery of the program stored in the memory 140, by using a preset recovery algorithm. For example, the electronic device 100 may receive image data again from the server 400 and change or replace the program stored in the memory 140 based on the received image data. For example, the electronic device 100 may change or replace the program stored in the memory 140, based on a backup binary that is stored in the memory 140 in response to the image data previously received from the server 400.

At operation S1170, if the integrity verification of the mounted program succeeds, the electronic device 100 may perform booting based on the mounted program.

FIG. 12 is a flowchart of a method of operating a server, according to an embodiment of the present disclosure.

Referring to FIG. 12, the server 400 may check the storage space of the electronic device 100 in which binaries used for updating a program are stored, at operation S1210. For example, the server 400 may check the size of the OS partition included in the memory 140 of the electronic device 100. The size of the OS partition included in the memory 140 of the electronic device 100 may vary depending on the model of the electronic device 100.

At operation S1220, the server 400 may determine whether it is necessary to separate and store binaries used for updating a program in different partitions of the memory 140 of the electronic device 100, based on the storage space of the electronic device 100.

For example, the server 400 may determine that it is necessary to separate and store the binaries in different partitions, when the total size of the binaries used for the update of the program exceeds the size of the OS partition.

At operation S1230, the server 400 may add a header to the binaries, when it is necessary to separate and store the binaries in different partitions of the memory 140 of the electronic device 100. For example, the server 400 may add a header to binaries to be stored in other partition other than the OS partition among the binaries used for the update of the program.

At operation S1240, the server 400 may generate image data. For example, the server 400 may generate image data by encoding, compressing, and/or packaging the binaries used for the update of the program into a format that can be processed by the controller 170 of the electronic device 100.

As described above, according to at least one embodiment of the present disclosure, the electronic device can update software, despite limitations in the size of the partition of the memory in which the program is stored.

In addition, according to at least one embodiment of the present disclosure, the electronic device can provide a function by utilizing a program stored in different partitions together.

Referring to FIGS. 1 to 12, the electronic device 100 according to an aspect of the present disclosure includes a memory 140 including a plurality of partitions; and a controller 170, in which the controller 170 obtains image data including binaries, in response to a performance of an update for a program stored in the memory 140, stores some of the binaries in a first partition, and stores remainder of the binaries in a second partition, when it is required to separate and store the binaries in the plurality of partitions, and stores the binaries in the second partition, when it is not required to separate and store the binaries in the plurality of partitions.

In addition, according to an aspect of the present disclosure, the first partition is a Read-Write (RW) partition to which user access is permitted, and the second partition is a Read-Only (RO) partition to which user access is restricted.

In addition, according to an aspect of the present disclosure, the controller 170 determines whether it is required to separate and store the binaries into the plurality of partitions, based on a result of checking whether some of the binaries include a header corresponding to the first partition.

In addition, according to an aspect of the present disclosure, the controller 170 determines whether it is required to separate and store the binaries into the plurality of partitions, based on the result of comparing a total size of the binaries with a size of the second partition.

In addition, according to an aspect of the present disclosure, the electronic device 100 further includes a user input interface 150; and a display 180, and the controller 170 outputs a message for a use of the first partition through the display 180, when it is required to separate and store the binaries into the plurality of partitions, stores the binaries in the first partition and the second partition, based on a reception, through the user input interface 150, of a first input agreeing to the use of the first partition, and stops the performance of the update, based on a reception, through the user input interface 150, of a second input disagreeing to the use of the first partition.

In addition, according to an aspect of the present disclosure, the controller 170 determines whether a storage space of the first partition for storing some of the binaries is insufficient, when it is required to separate and store the binaries into the plurality of partitions, and performs an operation of securing the storage space of the first partition in response to a size of some of the binaries, when the storage space of the first partition is insufficient.

In addition, according to an aspect of the present disclosure, the controller 170 secures the storage space of the first partition by deleting at least some of a temporary file stored in the first partition.

In addition, according to an aspect of the present disclosure, the memory 140 includes a first memory 500 including the plurality of partitions; and a second memory 600, and the controller 170 mounts a second binary stored in the second partition to the second memory 600, and mounts the first binary to the second memory 600 so that the first binary stored in the first partition is overlaid with the second binary mounted to the second memory 600.

In addition, according to an aspect of the present disclosure, a first layer of a overlay file system on which the first binary is mounted and a second layer of the overlay file system on which the second binary is mounted are a Read-Only (RO) layer.

In addition, according to an aspect of the present disclosure, the controller 170 performs integrity verification on a whole of the first binary and the second binary, which are overlay-mounted to the second memory 600, and, based on a failure of the integrity verification, performs recovery of the program stored in the memory 140.

A system according to an aspect of the present disclosure a server 400 and an electronic device 100, in which the server 400 generates image data including binaries, and the electronic device 100 obtains image data from the server 400, in response to a performance of an update for a program stored in a memory 140 of the electronic device 100, stores some of the binaries in a first partition, and stores remainder of the binaries in a second partition, when it is required to separate and store the binaries in a plurality of partitions of the memory 140, and stores the binaries in the second partition, when it is not required to separate and store the binaries in the plurality of partitions.

In addition, according to an aspect of the present disclosure, the first partition is a Read-Write (RW) partition to which user access is permitted, and the second partition is a Read-Only (RO) partition to which user access is restricted.

In addition, according to an aspect of the present disclosure, the server 400 determines whether it is required to separate and store the binaries in the plurality of partitions, based on a size of the binaries and a size of the second partition, and when it is required to separate and store the binaries in the plurality of partitions, adds a header corresponding to the first partition to some of the binaries, and then generates the image data, and the electronic device 100 determines whether it is required to separate and store the binaries in the plurality of partitions, based on a result of checking whether some of the binaries includes the header.

In addition, according to an aspect of the present disclosure, the memory 140 includes: a first memory 500 including the plurality of partitions; and a second memory 600, and the electronic device 100 mounts a second binary stored in the second partition to the second memory 600, and mounts the first binary to the second memory 600 so that the first binary stored in the first partition is overlaid with the second binary mounted to the second memory 600.

In addition, according to an aspect of the present disclosure, the electronic device 100 performs integrity verification on a whole of the first binary and the second binary, which are overlay-mounted to the second memory 600, and, based on a failure of the integrity verification, performs recovery of the program stored in the memory 140 by re-obtaining the image data from the server 400.

The effects of the electronic device and the system including the same according to the present disclosure are described as follows.

According to at least an embodiment of the present disclosure, the electronic device can update software, despite the limitation of the size of a partition of a memory where program is stored.

According to at least an embodiment of the present disclosure, the electronic device can provide a function by using a program stored in different partitions together.

Since the accompanying drawings are merely for easily understanding embodiments disclosed herein, it should be understood that the technical spirit disclosed herein is not limited by the accompanying drawings, and all changes, equivalents or substitutions are included in the spirit and technical scope of the present disclosure.

Meanwhile, an operation method of the present disclosure can also be embodied as processor readable code on a processor-readable recording medium. The processor-readable recording medium includes all kinds of recording apparatuses storing data that can be read by a processor. Examples of the processor-readable recording medium is ROM, RAM, CD-ROM, magnetic tapes, floppy disks, optical data storage apparatuses, and, including those that are implemented in the form of carrier waves such as data transmission through the Internet. In addition, the processor-readable recording medium is dispersed in computer systems connected through a network, so that the processor-readable code can be stored and executed in a distributed fashion.

While the present disclosure has been particularly shown and described with reference to exemplary embodiments thereof, it will be understood by those of ordinary skill in the art that various changes in form and detail may be made herein without departing from the spirit and scope of the present disclosure as defined by the following claims and such modifications and variations should not be understood individually from the technical idea or aspect of the present disclosure.

What is claimed is:

1. An electronic device comprising:
a memory including a plurality of partitions; and
a controller configured to:
obtain image data including binaries, in response to a performance of an update for a program stored in the memory,
store some of the binaries in a first partition, and store remainder of the binaries in a second partition, when it is required to separate and store the binaries in the plurality of partitions, and
store the binaries in the second partition, when it is not required to separate and store the binaries in the plurality of partitions.

2. The electronic device of claim 1, wherein the first partition is a Read-Write (RW) partition to which user access is permitted, and
the second partition is a Read-Only (RO) partition to which user access is restricted.

3. The electronic device of claim 1, wherein the controller is configured to determine whether it is required to separate and store the binaries into the plurality of partitions, based on a result of checking whether some of the binaries include a header corresponding to the first partition.

4. The electronic device of claim 1, wherein the controller determines whether it is required to separate and store the binaries into the plurality of partitions, based on the result of comparing a total size of the binaries with a size of the second partition.

5. The electronic device of claim 1, further comprising:
a user input interface; and
a display,
wherein the controller is configured to:
output a message for a use of the first partition through the display, when it is required to separate and store the binaries into the plurality of partitions,
store the binaries in the first partition and the second partition, based on a reception, through the user input interface, of a first input agreeing to the use of the first partition, and
stop the performance of the update, based on a reception, through the user input interface, of a second input disagreeing to the use of the first partition.

6. The electronic device of claim 1, wherein the controller is configured to:
determine whether a storage space of the first partition for storing some of the binaries is insufficient, when it is required to separate and store the binaries into the plurality of partitions, and
perform an operation of securing the storage space of the first partition in response to a size of some of the binaries, when the storage space of the first partition is insufficient.

7. The electronic device of claim 6, wherein the controller is configured to secure the storage space of the first partition by deleting at least some of a temporary file stored in the first partition.

8. The electronic device of claim 1, wherein the memory comprises:
a first memory including the plurality of partitions; and
a second memory,
wherein the controller is configured to:
mount a second binary stored in the second partition to the second memory, and
mount the first binary to the second memory so that the first binary stored in the first partition is overlaid with the second binary mounted to the second memory.

9. The electronic device of claim 8, wherein a first layer of a overlay file system on which the first binary is mounted and a second layer of the overlay file system on which the second binary is mounted are a Read-Only (RO) layer.

10. The electronic device of claim 8, wherein the controller is configured to:
perform integrity verification on a whole of the first binary and the second binary, which are overlay-mounted to the second memory, and,
based on a failure of the integrity verification, perform recovery of the program stored in the memory.

11. A system comprising a server and an electronic device,
wherein the server is configured to generate image data including binaries, and
wherein the electronic device is configured to:
obtain image data from the server, in response to a performance of an update for a program stored in a memory of the electronic device,
store some of the binaries in a first partition, and stores remainder of the binaries in a second partition, when it is required to separate and store the binaries in a plurality of partitions of the memory, and
store the binaries in the second partition, when it is not required to separate and store the binaries in the plurality of partitions.

12. The system of claim 11, wherein the first partition is a Read-Write (RW) partition to which user access is permitted, and
the second partition is a Read-Only (RO) partition to which user access is restricted.

13. The system of claim 11, wherein the server is configured to:
determine whether it is required to separate and store the binaries in the plurality of partitions, based on a size of the binaries and a size of the second partition, and
when it is required to separate and store the binaries in the plurality of partitions, add a header corresponding to the first partition to some of the binaries, and then generate the image data,
wherein the electronic device is configured to determine whether it is required to separate and store the binaries in the plurality of partitions, based on a result of checking whether some of the binaries includes the header.

14. The system of claim 11, wherein the memory comprises:
a first memory including the plurality of partitions; and
a second memory,
wherein the electronic device is configured to:
mount a second binary stored in the second partition to the second memory, and
mount the first binary to the second memory so that the first binary stored in the first partition is overlaid with the second binary mounted to the second memory.

15. The system of claim 14, wherein the electronic device is configured to:
perform integrity verification on a whole of the first binary and the second binary, which are overlay-mounted to the second memory, and,
based on a failure of the integrity verification, perform recovery of the program stored in the memory by re-obtaining the image data from the server.
